(19) United States
(12) Patent Application Publication
(10) Pub. No.: US 2026/0241566 A1
(43) Pub. Date: Aug. 20, 2026

(54) Method for Monitoring Lead Through Teaching

(71) Applicant: ABB Schweiz AG, Baden (CH)

(72) Inventors: Tobias Berninger, Türkenfeld (DE); Bjoern Matthias, Bad Schönborn (DE); Tomas Groth, Västerås (SE); Richard Roberts, Gilching (DE); Tomas Olsson, Enköping (SE)

(73) Assignee: ABB Schweiz AG, Baden (CH)

(21) Appl. No.: 19/641,097

(22) Filed: Apr. 7, 2026

Related U.S. Application Data
(63) Continuation of application No. PCT/EP2023/077917, filed on Oct. 9, 2023.

(51) Int. Cl. B25J 9/16; G05B 19/423

(52) U.S. Cl. CPC B25J 9/1676; B25J 9/163; G05B 19/423

(57) ABSTRACT

A computer implemented method for monitoring the lead through teaching of a robot in a human robot collaboration environment, comprising: receiving a velocity vector of an element of the robot; receiving a force vector of the of the element of the robot; determining a safety result based on the received velocity vector and the received force vector; and triggering a safety stop based on the determined safety result.

### CROSS-REFERENCE TO RELATED APPLICATIONS

The instant application claims priority to International Patent Application No. PCT/EP2023/077917, filed Oct. 9, 2023, which is incorporated herein in its entirety by reference.

### FIELD OF THE DISCLOSURE

The present disclosure generally relates to a computer implemented method for monitoring lead through teaching of a robot in a human robot collaboration environment, and to a data processing device, a computer program, a computer readable medium, and a system.

### BACKGROUND OF THE INVENTION

Human robot collaboration is known in the state-of-the-art. Lead through teaching is a procedure type in human robot collaboration and known in the state-of-the-art. Lead through teaching relates to a way of programming a robot. For this purpose, a programmer moves the robot to a desired position. All coordinates reached in this way are stored in the control system. A hazard in lead through teaching during human robot collaboration is a collision of the robot with the human. The collision may comprise clamping and impacts. Different safety methods are used to mitigate the safety impact of such collisions. For example, velocity thresholds and/or force thresholds are applied during lead through teaching. However, such velocity and/or force thresholds can cause unwanted protective stops during lead through teaching.

### BRIEF SUMMARY OF THE INVENTION

In view of the above, the present disclosure generally describes a method for monitoring lead through teaching of a robot in a human robot collaboration environment.

In one aspect of the present disclosure, a computer implemented method for monitoring lead through teaching of a robot in a human robot collaboration environment is provided, comprising the steps of: receiving velocity vector of an element of the robot; receiving a force vector of the element of the robot; determining a safety result based on the received velocity vector and the received force vector; triggering a safety stop based on the determined safety result.

### BRIEF DESCRIPTION OF THE SEVERAL VIEWS OF THE DRAWING(S)

FIG. 1 is a flowchart of a method for lead through teaching of a robot in a human robot collaboration environment in accordance with the disclosure.

FIG. 2 is a diagram of a robot in a first situation of lead through teaching in accordance with the disclosure.

FIG. 3 is a diagram of a robot in a further situation of lead through teaching in accordance with the disclosure.

FIG. 4 is a diagram of a robot in a further situation of lead through teaching in accordance with the disclosure.

FIG. 5 is a graph of an example of a band pass filter in accordance with the disclosure.

### DETAILED DESCRIPTION OF THE INVENTION

FIG. 1 shows a flow diagram of an example method for lead through teaching of a robot in a human robot collaboration environment. Step S 100 comprises receiving a velocity vector of an element of the robot. The robot is preferably an articulated robot with a safety controller carrying out the method described herein. The element is in this example a tool centre point (TCP) of a welding tool of the robot. The robot is arranged in a human robot collaboration environment. A human may teach the robot one or more positions for a welding in an exemplary use case. The velocity vector is determined by means of a multi body model that considers structural geometries of one or more elements of a robot, a movement of the one or more elements, and a position of the one or more elements of the robots. The velocity vector is provided to the method by means of an interface to the safety controller carrying out the described method.

Step S 200 comprises receiving a force vector of the element of the robot. The robot comprises in the present example a force sensor at the TCP. The force vector is provided to the method by means of an interface to the safety controller carrying out the described method.

S300 comprises determining a safety result based on the received velocity vector and the received force vector. In the present example, the safety result is determined by calculating a power by calculating a scalar product of the velocity vector and the force vector and further assessing a sign of the calculated power.

S 400 comprises triggering a safety stop based on the determined safety result. In the present example, should the sign of the calculated power be negative, a safety stop is triggered. The safety stop may comprise a retraction of the element of the robot to release clamping. The stop of the robot motion may be a category 1 stop or a category 2 stop. Should the sign of the calculated power be positive, no safety stop is triggered. In case no safety stop is triggered, the human may guide the robot, particularly the TCP of the robot further to a desired position.

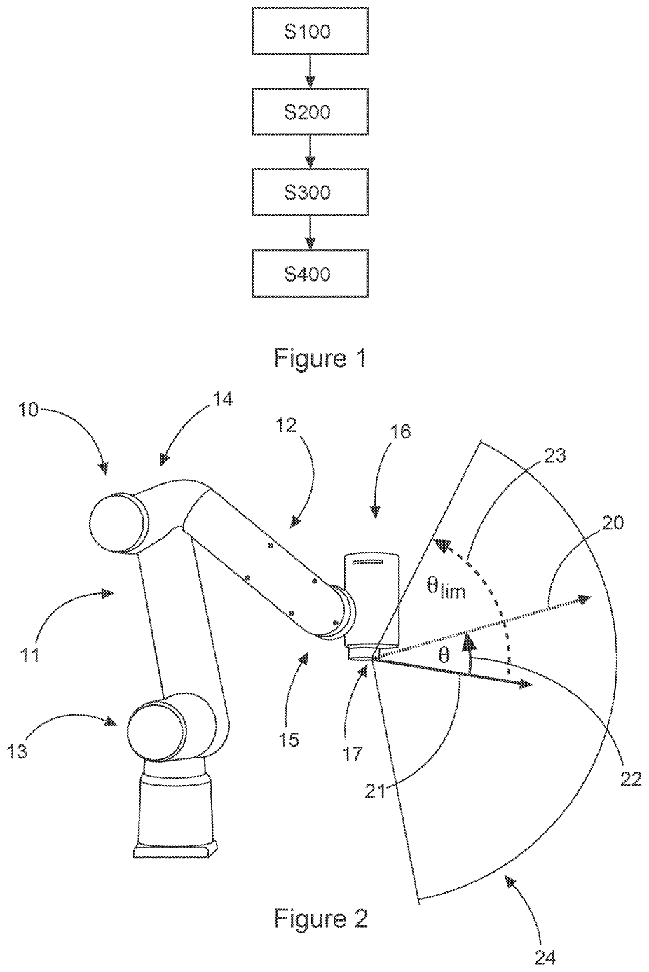

FIG. 2 shows an illustration of a robot in a first situation of lead through teaching. The robot 10 is in the present example an articulated robot with two arms 11 and 12, three joints 13, 14 and 15, and a tool holder 16. The TCP 17 is set at a tip of the tool holder 16. In the present example, the velocity vector 21 and the force vector 22 have their origin in the TCP 17. In the present example, the safety result comprises a predefined threshold angle θ_{lim¿¿} 23. The predefined threshold angle θ_{lim¿¿} 23 extends from the velocity vector 21 in both directions and forms a cone 24. In case the angle θ 22 between force vector 20 and velocity vector 21 is equal or less than the predefined threshold angle θ_{lim¿ ¿}23, no safety stop is triggered. In case the angle θ 22 between force vector 20 and velocity vector 21 is larger than the predefined threshold angle θ_{lim¿¿} 23, the safety stop is triggered. In the present example, the force vector 20 lies within the cone 24 and therefore the angle 22 is less than predefined threshold angle θ_{lim¿¿} 23. Therefore, the force vector is interpreted as a guiding force as it is directed in a similar direction to the velocity vector. Hence, no safety stop is triggered, and a human can move the robot further to a desired position.

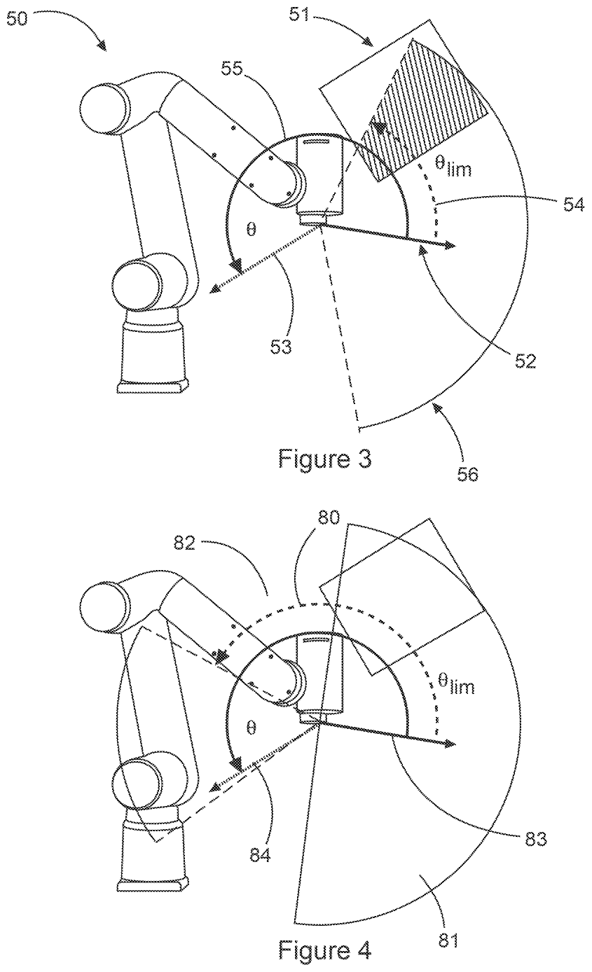

FIG. 3 shows an illustration of a robot in a second situation of lead through teaching. In contrast to FIG. 2, the robot 50 collides in this example with a clamping surface 51. The cone 56 formed around the velocity vector 52 by the predefined threshold angle θ_{lim¿¿} 54 remains the same as in FIG. 2. However, the force vector 53 is directed in the opposite direction to the velocity vector 52. Therefore, the angle θ 55 between velocity vector and force vector is larger than the predefined threshold angle θ_{lim¿¿} 54. In this situation, the method triggers a safety stop. The force 53 is interpreted as clamping force. A human is not able to move the robot to a further position as the method disables the drives.

FIG. 4 shows an illustration of a robot in a further situation of lead through teaching. In contrast to FIG. 3, the predefined threshold angle θ_{lim¿¿} 80 is larger than 90°. The collision situation is the same as in FIG. 3. The area formed by the predefined threshold angle θ_{lim¿¿} 80 comprises two regions 81 and 82. Region 81 relates to a region, wherein the angle θ between the velocity vector 83 and the force vector 84 is less than 90°. Therefore, the force vector is interpreted as a guiding force. Region 82 is a region, wherein the angle θ between the velocity vector 83 and the force vector 84 is larger than 90° and less than the predefined threshold angle θlim¿¿ 80. Therefore, the force vector is interpreted as stop vector. Region 85 is a region, wherein the angle between velocity vector 83 and the force vector 84 is larger than the predefined threshold angle θ_{lim¿¿} 80. Therefore, the force vector is interpreted as a clamping force. In the present example, the force vector 84 is interpreted as clamping force and a safety stop is triggered.

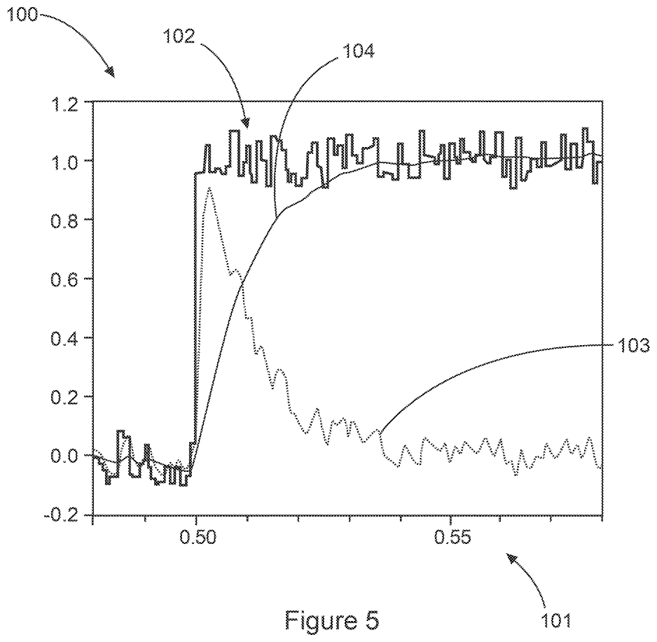

FIG. 5 shows an illustration of a filter applied to a force vector and velocity vector. The vertical axis 100 shows the signal amplitude. The horizontal axis 101 shows the timeline. The graph 102 shows an incoming signal. The incoming signal 102 comprises either the velocity vector or the force vector. The incoming signal 102 is divided into a high frequency input component 103 and a low frequency input component 104. At time 0.5 a fast change in the input signal 102 occurs. Consequently, the low frequency input component 103 increases slowly and then remains high. The high frequency input component 104 increases rapidly and falls again once the fast change is over. The method described above applies such a filter to the velocity vector and/or the force vector to distinguish between high frequency changes and low frequency changes. For fast changes in the force vector and/or velocity vector, a safety stop may be triggered immediately. For slow changes in the force vector and/or velocity vector, the above-described measures may be applied to differentiate between guiding force, clamping force and/or stopping force.

The term lead through teaching, as used herein, is to be understood broadly and may relate to hand guidance programming. During hand guidance, programming an operator may physically move the robot through one or more waypoints of a desired task. Lead through teaching may be used in tasks like welding, paint spraying, or applying adhesives on structural elements. Lead through teaching may be applied to single tasks or recurring tasks.

The term robot, as used herein, is to be understood broadly and may relate to any electromechanical manipulator with one or more drive axes and a control. Preferably, the robot may comprise at least a wrist, an arm, a drive axis, and a control. The drive axis may comprise an electric motor and a gear. The robot may comprise a sensor configured to measure a position of an arm. The position may comprise an angle. The sensor may be an encoder. The robot may comprise a torque sensor configured to measure a torque. The robot may comprise a current sensor configured to measure a motor current. The robot may comprise a sensor configured to measure a torsion of between a motor and a gear.

The term human robot collaboration environment, as used herein, is to be understood broadly and may relate to any environment in which a human works in the direct vicinity of a robot such that the robot could touch the human and vice versa. Human robot collaboration preferably may relate to a co working of a human and a robot to carry out a task. The human robot collaboration environment may comprise a robot configured to be lead through taught by an operator. The human robot collaboration environment may comprise a robot with a welding tool, a painting tool, an adhesive tool, and/or other end effectors known from the state of the art.

The term element of a robot, as used herein, is to be understood broadly may relate to any part of the robot. The element may be an arm, a wrist, a tool centre point (TCP), a tool, and/or an elbow. The element may be an effector mounted to the robot.

The term velocity vector, as used herein, preferably relates to a velocity vector of an element of the robot. The velocity vector preferably consists of a magnitude of the velocity multiplied by a direction in a chosen coordinate system. For example, a velocity vector of an arm of the robot may relate to a vector between a point of the element and a further point in vicinity, or to a point of the element and a corresponding direction. The point may be a corner of the element, a centre of mass of the element, a centre of surface of the element, a centre of volume of the element. The point may be any point of the element of the robot. The point of the velocity vector and a point of a force vector may preferably be identical. The velocity vector may be determined by means of a multi body model that takes into account structural geometries of one or more elements of a robot, a movement of the one or more elements, and a position of the one or more elements of the robots. The multi body model may receive sensor data and/or machine control data from the robot in order to determine the velocity vector. The multi body model may be implemented in a control of the robot. The velocity vector may be provided to the method by means of an interface of a data processing device carrying out the described method.

The term force vector, as used herein, preferably relates to a force vector an element of the robot. The force vector preferably consists of a magnitude of the force multiplied by a direction in a chosen coordinate system. For example, a force vector of an arm of the robot may relate to a vector between a point of the element and a further point in vicinity, or to a point of the element and a direction. The point may be a corner of the element, a centre of mass of the element, a centre of surface of the element, a centre of volume of the element. The point may be any point of the element of the robot. The point of the force vector and the velocity vector may preferably be identical. The force vector may be determined with a multi body model. The multi body model may take into account structural geometries and weights of one or more elements of a robot, a movement of the one or more elements, a position of the one or more elements of the robot, and one or more loads applied to the one or more elements of the robot. The multibody model may receive sensor data and/or machine control data to determine the force vector. The sensor data may comprise data from a torque sensor, a motor current sensor, an encoder, a torsion sensor. The multibody model may be implemented in a control of the robot. The robot may comprise a force sensor at an end effector of the robot. The robot may comprise a torque sensor at the end effector of the robot. The force vector may be determined by kinematic projection to any element (respectively any specific point of any element) of the robot. The force vector may be determined via joint torque measurement and kinematic projection to any element (respectively any point of any element) of the robot. In this case, gravity and inertial loads may be considered too. A disturbance-torque may be determined by comparing the predicted joint-torques via a dynamic model of the robot arm to the measured joint torque. The force vector may then be determined by a kinematic projection of the disturbance-torques to any point of the robot. The joint torque measurement may be measured by a torque sensor, motor/arm-side sensor, and/or a motor current sensor. The force vector may be provided to the method by means of an interface of a data processing device carrying out the described method.

The term safety result, as used herein, is to be understood broadly and may relate to any calculation result taking into account a force vector of an element and a velocity vector of the same element. In other words, determining a safety result based on the received velocity vector and force vector means that both vectors are processed together and not independently from each other.

The term safety stop, as used herein, is to be understood broadly and may relate to a stop of the robot motion or to a retraction of the element of the robot to release clamping.

Current safety functions such as Tool Force Supervision in lead through teaching in a human robot collaboration environment do not differentiate between desired guiding forces and unwanted clamping forces. Every external force acting on the robot (i.e. manipulator) is interpreted as a potential clamping force and will lead to a protective stop after crossing a preconfigured external force threshold. To guarantee that clamping forces stay below biomechanical pain thresholds, a maximum speed threshold is supervised in addition to the preconfigured external force threshold. This creates the following problems: for an operator is difficult to stay below the necessary speed thresholds when guiding the robot with lead through teaching. This causes frequent unwanted protective stops due to tripping the speed threshold. To balance this, for example, more resistance may be added to the lead through teaching function to help the user to remain within the maximum speed threshold. However, the operator then needs to exert more guidance force on the robot, which is then interpreted as a clamping force by a power force limiting algorithm. This leads then again to frequent protective stops by tripping the force threshold. The invention proposes, instead of checking absolute thresholds on speeds (i.e. velocity) and external forces separately, to combine the checking of speed and external force by checking the direction of the speed vector and the direction of the force vector. If both vectors point in a similar direction, an end effector is following a guidance force and there is therefore no clamping situation. If they point in opposite directions, a motion of the end effector is constrained by an external force, which could be a dangerous clamping force. This may be advantageous as it reduces unwanted safety stops and therefore increases the efficiency of lead through teaching in combination with the high safety of the human in the human robot collaboration environment.

In an embodiment of the method, the determining the safety result may comprise a calculation of a power and an assessment of a sign of the calculated power and if the sign is negative, triggering the safety stop. The power may be calculated by computing a scalar product from the velocity vector and the force vector: P=F⋅v

In case the scalar product is positive, an angle between the velocity vector and the force vector is acute. An acute angle reveals that the force vector and the velocity are directed in a similar direction. In case the scalar product is negative, an angle between the velocity vector and the force vector is obtuse. An obtuse angle reveals that the force vector and the velocity are directed in rather opposite directions. Based on the assessment of the sign (i.e., positive or negative) the safety stop is triggered. For example, if the sign is negative, the safety stop is triggered. For example, if the sign is positive, no safety stop is triggered. The sign may allow differentiating between dangerous and non-dangerous external forces. A positive sign means that a motion of a supervised part of the robot may roughly follows the external force. This may mean that the robot is following a guidance force, which is the intended function. This may advantageously solve the issue of triggering falsely on high guidance forces with high lead through resistance in order to guarantee slow speeds for sensible power force limiting triggering limits. A negative sign may mean that the current motion may be opposed by the external force. This could either be the operator rapidly changing the lead through direction from e.g. left to right, or the robot pushing into a contact because of a fault of the control system.

In an embodiment of the method, the determining the safety result may comprise a calculation of an angle between the force vector and the velocity vector and a comparison with a predefined threshold angle and, if the calculated angle exceeds the predefined threshold angle, triggering the safety stop. The provision of a predefined threshold angle may allow the method to be more restrictive in case the threshold angle is below 90° or to be less restrictive in case the threshold angle is above 90°. The angle may be calculated by the following equation:

$$\\ θ = {cos}^{- 1} ( \frac{( F \cdot v )}{\vert F \vert \vert v \vert} )$$

The threshold angle may allow defining a cone around the velocity vector, within which the force vector is allowed to point. This may permit a guiding force to be distinguished from a clamping force.

In an embodiment of the method, the predefined threshold angle may be less than 90°. A threshold angle smaller than 90° may enable a safer lead through teaching of the robot, as the method is more restrictive in comparison to an assessment of a sign of the scalar product of the force vector and the velocity vector.

In an embodiment of the method, the predefined threshold angle may be greater than 90°. A threshold angle greater than 90° may allow distinguishing between stopping forces and clamping forces. The term stopping force, as used herein, may relate to a force that is used by the operator to reduce a velocity of the robot, in particular of the element (e.g. TCP) of the robot. In case the angle between the velocity vector and the force vector is between a threshold angle that is greater than 90° and an angle of 90°, the force vector may be a stopping force. In case the respective angle is smaller than 90°, the force vector may be a guiding force. In case the respective angle is greater than the threshold angle, the force vector may be a clamping force and may therefore lead to a triggering of the safety stop otherwise no safety stop may be triggered. This may allow making the lead through teaching more robust against unwanted safety stops.

In an embodiment of the method, if the calculated angle is above the predefined threshold angle, the method may further comprise determining a time duration since when the calculated angle is above the predefined angle and may comprise comparing the determined time duration with a predefined time duration. Should the determined time duration be below the predefined time duration, the method may comprise not triggering the safety stop; and should the determined time duration exceed the predefined time duration, the method may comprise triggering the safety stop.

In other words, the force vector is allowed to leave the predefined angle for a certain amount of time. The time duration may be, for example, 0.01 s or less. This may advantageously increase the robustness of the method against unwanted safety stops. Furthermore, the force vector may be allowed to leave the predefined angle as long as the magnitude of the force is below a predefined threshold. This will increase the robustness of the method against the user deliberately braking the robot by hand as part of the lead through process.

In an embodiment, the method may further comprise transforming the received velocity vector and the received force vector into their respective low and high frequency components in the frequency domain; comparing the low frequency component of the velocity with a low frequency velocity threshold and comparing the low frequency component of the force vector with a low frequency force threshold; if the low frequency component of the velocity and/or the low frequency component of the force exceeds the respective thresholds, triggering the safety stop; comparing the high frequency component of the velocity with a high frequency velocity threshold and comparing the high frequency component of the force vector with a high frequency force threshold; if the high frequency component of the velocity and/or the high component of the force exceeds the respective thresholds, triggering the safety stop.

The method may split the velocity vector and/or the force vector into low and high frequency components. In other words, the method distinguishes between slow changes of the force vector and the velocity vector (i.e. low frequencies of the transformed vectors) and fast changes of the force vector and the velocity vector (i.e. high frequencies of the transformed vectors). For fast changes in the force vector and/or the velocity vector a safety stop is triggered immediately. For slow changes in the force vector and/or velocity vector the above-described measures may be applied to differentiate between guiding force, clamping force and/or stopping force. This may be advantageous regarding safety aspects, since distinguishing between guiding force, clamping force and/or stopping force may be time-consuming. This may lead to a longer reaction time. Therefore, in case high-frequency changes occur in the velocity vector and/or the force vector, it may be beneficial to trigger the safety stop immediately. This may be a simple comparison with predefined force threshold and/or a comparison with predefined velocity threshold. In other words, the velocity vector signal and force vector signal are split into a high frequency component and low frequency component. Different monitoring strategies may then be applied to these components. For example, for the high frequency component: the force vector may compare with a predefined force threshold. Similarly, for the low frequency component: the force vector may analyzed to distinguish between guiding force, clamping force and/or stopping force.

In an embodiment of the method, the determining the safety result may comprise comparing a magnitude of the velocity vector with a predefined velocity threshold and comparing a magnitude of the force vector with a predefined force threshold; if the velocity vector is below the predefined velocity threshold, determining a time duration since when the velocity vector is below the predefined velocity threshold and comparing the determined time duration with a predefined time duration and if the determined time duration is above the predefined time duration and the force vector is above the predefined force threshold, triggering the safety stop.

Clamping can essentially only happen at zero velocity. The robot may in such a situation stick and still push into a contact. In other words, the method may detect whether the robot is stuck or begins to stick by determining a very small velocity with a simultaneous high force and/or high force increase. The predefined velocity threshold may relate to a range around zero velocity. The predefined velocity threshold may be 0.05 m/s or smaller. The predefined time duration may be 0.1 s or smaller. The predefined force threshold may be 100 N, 1.0 KN or larger. This may advantageously increase the safety of the lead through teaching.

In an embodiment of the method, the lead through teaching may be based on an admittance-based lead through control. In this way, the velocity can be very easily limited in a velocity-loop of the functional controller to just under a speed limit for the motion supervision safety function. If the user then tries to pull harder to make the robot move faster, the increased external force can be identified as a guidance force using the approach described above in order to not falsely trigger a safety stop.

In an embodiment of the method, the method may further comprise providing an artificially generated resistance against motion. This may be advantageous in order to prevent the user causing velocity supervision violations. This may advantageous as it makes it easier to clearly identify the velocity and/or force vector. The artificial resistance may be provided by adding damping to a lead through teaching controller.

In an embodiment of the method, the method may be implemented in a safety controller of the robot. The term safety controller, as used herein, is to be understood broadly and preferably may relate to a safety programmable logic controller.

A further aspect of the present disclosure relates to a data processing device comprising means for carrying out the method described above.

A further aspect of the present disclosure relates to a computer program comprising instructions, which, when the program is executed by a computer, cause the computer to carry out the method as described above.

A further aspect of the present disclosure relates to a computer-readable medium comprising instructions which, when executed by a computer, cause the computer to carry out the method as described above.

A last aspect of the present disclosure relates to a system comprising a robot and a data processing device as described above configured to carry out a method as described above.

Devices may include one or more interface circuits. In some examples, the interface circuits may include wired or wireless interfaces that are connected to a local area network (LAN), the Internet, a wide area network (WAN), or combinations thereof. The functionality of any given device or unit of the present disclosure may be distributed among multiple units or devices that are connected via interface circuits. Devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof.

Any disclosure and embodiments described herein relate to the methods, the systems, the devices, the computer program element lined out above and vice versa. Advantageously, the benefits provided by any of the embodiments and examples equally apply to all other embodiments and examples and vice versa.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCE LIST

S100 receiving a velocity vector

S200 receiving a force vector

S300 determining a safety result

S400 triggering a safety stop

10, 50 robot

11, 12 arm

13, 14, 15 joint

16 tool holder

17 TCP

20, 53, 84 force vector

21, 52, 83 velocity vector

22, 55 angle

23, 54, 80 threshold angle

24, 56 cone

51 clamping surface

81, 82, 85 region

100 vertical axis

101 horizontal axis

102 input signal

103 high frequency

104 low frequency

What is claimed is:

1. A computer implemented method for monitoring lead through teaching of a robot in a human robot collaboration environment, comprising:
receiving a velocity vector of an element of the robot;
receiving a force vector of the element of the robot;
determining a safety result based on the received velocity vector and the received force vector;
triggering a safety stop based on the determined safety result.

2. The method according to claim 1, wherein the determining the safety result comprises a calculation of a power and an assessment of a sign of the calculated power and, if the sign is negative, triggering the safety stop.

3. The method according to claim 1, wherein determining the safety result comprises a calculation of an angle between the force vector and the velocity vector and a comparison with a predefined threshold angle and, when a magnitude of the calculated angle is above the predefined threshold angle, triggering the safety stop.

4. The method according to claim 3, wherein the predefined threshold angle is less than 90°.

5. The method according to claim 3, wherein the predefined threshold is greater than 90°.

6. The method according to claim 3, wherein when the calculated angle is above the predefined threshold angle, the method further comprises:
determining a time duration since when the calculated angle is above the predefined angle and comparing the determined time duration with a predefined time duration; and
when the determined time duration is below the predefined time duration, not triggering the safety stop; or
when the determined time duration is above the predefined time duration triggering the safety stop.

7. The method according to claim 1, further comprising:
transforming the received velocity vector and the received force vector into their respective low and high frequency components in the frequency domain;
comparing the low frequency component of the velocity with a low frequency velocity threshold and comparing the low frequency component of the force vector with a low frequency force threshold;
when the low frequency component of the velocity and/or the low frequency component of the force exceeds the respective thresholds, triggering the safety stop;
comparing the high frequency component of the velocity with a high frequency velocity threshold and comparing the high frequency component of the force vector with a high frequency force threshold; and
when the high frequency component of the velocity and/or the high component of the force exceeds the respective thresholds, triggering the safety stop.

8. The method according to claim 1, wherein the determining the safety result comprises comparing a magnitude of the velocity vector with a predefined velocity threshold and comparing a magnitude of the force vector with a predefined force threshold.

9. The method according to claim 8, wherein when the velocity vector is below the predefined velocity threshold, the method further comprises determining a time duration since when the velocity vector is below the predefined velocity threshold and comparing the determined time duration with a predefined time duration, when the determined time duration is above the predefined time duration and the force vector is above the predefined force threshold, triggering the safety stop.

10. The method according to claim 1, wherein lead through teaching is based on an admittance-based lead through control.

11. The method according to claim 1, further comprising providing an artificially generated resistance against moving the robot.

12. The method according to claim 1, wherein the method is implemented in a safety controller of the robot.

13. A computer program comprising instructions which, when the program is executed by a computer, cause the computer to carry out a computer implemented method for monitoring lead through teaching of a robot in a human robot collaboration environment, the computer program comprising:
instructions for receiving a velocity vector of an element of the robot;
instructions for receiving a force vector of the element of the robot;
instructions for determining a safety result based on the received velocity vector and the received force vector; and
instructions for triggering a safety stop based on the determined safety result.
